(19) United States
(12) Patent Application Publication
(10) Pub. No.: US 2023/0316244 A1
(43) Pub. Date: Oct. 5, 2023

(54) COMPUTERIZED VALUE-ADDED TAX SYSTEM

(71) Applicant: Vertex, Inc., King of Prussia, PA (US)

(72) Inventors: John Mccarthy, Killorglin (IE); Iman Ben Abbes, Amsterdam (NL); Tomek Lipski, Warsaw (PL)

(21) Appl. No.: 18/192,514

(22) Filed: Mar. 29, 2023

Related U.S. Application Data
(60) Provisional application No. 63/362,297, filed on Mar. 31, 2022.

(51) Int. Cl. G06Q 20/10; G06Q 20/40

(52) U.S. Cl. CPC G06Q 20/102; G06Q 20/405

(57) ABSTRACT

A computerized value-added tax (VAT) system comprising a VAT calculation server including a processor and associated memory is provided. The processor is configured to execute instructions using the memory to receive from a payment processor server system, at least one of a plurality of VAT calculation parameters associated with a payment transaction. The processor is further configured to determine a location of a consumer based upon the at least one of the plurality of VAT calculation parameters, perform a determination of a VAT percentage based upon the at least one of the plurality of VAT calculation parameters and the location of the consumer. The processor is further configured, if the determination is successful, and in communication with the payment processor server system, to transmit the determined VAT percentage along with a successful calculation message, and send a request for transfer of VAT funds for the payment transaction.

### CROSS REFERENCE TO RELATED APPLICATIONS

The present application is based upon and claims priority under 35 U.S.C. 119(e) to U.S. Provisional Patent Application No. 63/362,297, entitled COMPUTERIZED VALUE-ADDED TAX SYSTEM, filed Mar. 31, 2022, the entirety of which is hereby incorporated herein by reference for all purposes.

### BACKGROUND

In many countries, merchants are required to collect a value-added tax (VAT) for sales and to remit the VAT to tax authorities. A duty to pay VAT can arise for both in-store sales and online sales, for both digital goods and services, and physical goods, depending on the circumstances, geographic region, etc. Merchants are increasingly providing online shops, which may be accessed by customers from around the world, to sell both digital goods (such as licensed copies of software) and services (such as online courses), as well as physical goods. The VAT issues multiply in complexity for online sales involving international customers. In order to sell internationally, merchants must determine the VAT based upon the country to which a sale is being made, the type of good or service being sold, and other factors. Additionally, each country has its own tax authority to which the merchant must remit funds. Performing VAT calculations based upon differing regulations in multiple countries and dealing with multiple tax authorities in an automated manner for online sales presents a serious technical challenge to many merchants. Therefore, a challenge exists in providing a technical solution to addressing these complexities.

### SUMMARY

A computerized value-added tax (VAT) system is provided. In accordance with a first aspect of the present invention, the computerized VAT system comprises a VAT calculation server including a processor and associated memory. The processor is configured to execute instructions using the memory to receive from a payment processor server system, at least one of a plurality of VAT calculation parameters associated with a payment transaction. The processor is further configured to determine a location of a consumer based upon the at least one of the plurality of VAT calculation parameters. The processor is further configured to perform a determination of a VAT percentage based upon the at least one of the plurality of VAT calculation parameters and the location of the consumer. The processor is further configured, if the determination is successful, then transmit the determined VAT percentage to the payment processor server along with a successful calculation message that indicates the payment transaction can be processed, send a request for transfer of VAT funds for the payment transaction to the payment processor server system, and receive a confirmation of transfer of VAT funds from the payment processor server system. The processor is further configured to, if the determination is not successful, transmit a failure message that indicates that the payment transaction cannot be processed to cause the payment processor server system to refrain from processing the payment transaction.

With the computerized VAT system according to the first aspect, it is possible for a point-of-sale system to receive the determined VAT percentage from the computerized VAT system instead of locally determining the VAT percentage, thus reducing memory requirements at the point-of-sale system. Further, by not processing the payment transaction if the determination is not successful, it is possible reduce processing demands at the point-of-sale system, and increase the accuracy of the processed transactions.

In accordance with a second aspect of the present invention, the computerized VAT system according to the first aspect is provided, wherein the plurality of VAT calculation parameters include a plurality of consumer parameters selected from the group consisting of a consumer billing address, a consumer payment address, an IP address associated with the consumer, a VAT number associated with the consumer, a self-declared location of the consumer, a telephone number of the consumer, and a payment method of the consumer.

With the computerized VAT system according to the second aspect, it is possible to determine a location of the consumer for use in determining the VAT percentage.

In accordance with a third aspect of the present invention, the computerized VAT system according to the second aspect of the present invention is provided, wherein the location of the consumer is determined by the consumer billing address.

With the computerized VAT system according to the third aspect, it is possible to determine a country, a region, and/or a city of the location of the consumer.

In accordance with a fourth aspect of the present invention, the computerized VAT system according to the second aspect of the present invention is provided, wherein the location of the consumer is determined by the consumer payment address.

With the computerized VAT system according to the fourth aspect, it is possible to determine a country, a region, and/or a city of the location of the consumer.

In accordance with a fifth aspect of the present invention, the computerized VAT system according to the second aspect is provided, wherein the location of the consumer is determined by one or more of the consumer billing address, the consumer payment address, the IP address associated with the consumer, and the VAT number associated with the consumer.

With the computerized VAT system according to the fifth aspect, it is possible to reduce an error in the determination of the location of the consumer.

In accordance with a sixth aspect of the present invention, the computerized VAT system according to the first aspect is provided, wherein the plurality of VAT calculation parameters include a plurality of goods and services parameters selected from the group consisting of an identity of the good or service, a quantity of the good or service, and a point of origin of the good or service.

With the computerized VAT system according to the sixth aspect, it is possible to determine the corresponding VAT regulations pertaining to the good or service at the processor, and thus help to reduce processing demands at a point-of-sale system.

In accordance with a seventh aspect of the present invention, the computerized VAT system according to the sixth aspect is provided, wherein the determination of the VAT percentage is based on the identity of the good or service.

With the computerized VAT system according to the seventh aspect, it is possible to determine the corresponding VAT regulations pertaining to the identity of the good or service at the processor, and thus help to reduce processing demands at a point-of-sale system.

In accordance with an eighth aspect of the present invention, the computerized VAT system according to the first aspect is provided, the processor being further configured to receive a refund confirmation from the payment processor server system and in response to receiving the refund confirmation, send a VAT refund message to the payment processor server system.

With the computerized VAT system according to the eighth aspect, it is possible to refund a VAT refund when a customer returns a good or service purchased.

In accordance with a ninth aspect of the present invention, a computerized value-added tax (VAT) method for use with a server including a processor and associated memory is provided, the processor being configured to execute instructions using the memory, the method comprising, at the processor, receiving from a payment processor server system, at least one of a plurality of VAT calculation parameters associated with a payment transaction, determining a location of a consumer based upon the at least one of the plurality of VAT calculation parameters, and performing a determination of a VAT percentage based upon the at least one of the plurality of VAT calculation parameters and the location of the consumer. The method further comprises, if the determination is successful, then transmitting the determined VAT percentage to the payment processor server system along with a successful calculation message that indicates the payment transaction can be processed, sending a request for transfer of VAT funds for the payment transaction to the payment processor server system, and receiving a confirmation of transfer of VAT funds from the payment processor server system. The method further comprises transmitting, if the determination is not successful, a failure message that indicates that the payment transaction cannot be processed to cause the payment processor server system to refrain from processing the payment transaction.

With the method according to the ninth aspect, it is possible for a point-of-sale system to receive the determined VAT percentage from the computerized VAT system instead of locally determining the VAT percentage, and thus reduce memory requirements at the point-of-sale device. Further, if the determination is not successful, it is possible to reduce processing invalid payment transitions and reduce processing demands at the point-of-sale system.

In accordance with a tenth aspect of the present invention, the method according to the eighth aspect is provided, wherein the plurality of VAT calculation parameters include a plurality of consumer parameters selected from the group consisting of a consumer billing address, a consumer payment address, an IP address associated with the consumer, a VAT number associated with the consumer, a self-declared location of the consumer, a telephone number of the consumer, and a payment method of the consumer.

With the computerized VAT system according to the tenth aspect, it is possible to determine a location of the consumer.

In accordance with an eleventh aspect of the present invention, the method according to the tenth aspect is provided, wherein the location of the consumer is determined by one or more of the consumer billing address, the consumer payment address, IP address associated with the consumer, and the VAT number associated with the consumer.

With the computerized VAT system according to the eleventh aspect, it is possible to reduce an error in the determination of the location of the consumer.

In accordance with a twelfth aspect of the present invention, the method according to the ninth aspect is provided, wherein the plurality of VAT calculation parameters include a plurality of goods and services parameters selected from the group consisting of an identity of the good or service, a quantity of the good or service, and a point of origin of the good or service.

With the method according to the twelfth aspect, it is possible to determine the corresponding VAT regulations pertaining to the good or service at the processor, and thus help to reduce processing demands at the point-of-sale system.

In accordance with a thirteenth aspect of the present invention, the method according to the twelfth aspect is provided, wherein the determination of the VAT percentage is based on the identity of the good or service.

With the method according to the thirteenth aspect, it is possible to determine the corresponding VAT regulations pertaining to the identity of the good or service at the processor, and thus help to reduce processing demands at a point-of-sale system.

In accordance with a fourteenth aspect of the present invention, the method according to the ninth aspect further comprises, receiving a refund confirmation from the payment processor server system and in response to receiving the refund confirmation, sending a VAT refund message to the payment processor server system.

With the method according to the fourteenth aspect, it is possible to refund a VAT refund when a customer returns a good or service purchased.

In accordance with a fifteenth aspect of the present invention, a computerized value-added tax (VAT) system is provided, comprising a VAT calculation server including a processor and associated memory. The processor is configured to execute instructions using the memory to receive from a payment processor server system, at least one of a plurality of VAT calculation parameters associated with a payment transaction, determine a location of a consumer based upon the at least one of the plurality of VAT calculation parameters, perform a determination of a VAT percentage based upon the at least one of the plurality of VAT calculation parameters and the location of the consumer. The processor is further configured to, if the determination is successful, then transmit the determined VAT percentage to the payment processor server system along with a successful calculation message that indicates the payment transaction can be processed, send a request for transfer of VAT funds for the payment transaction to the payment processor server system, receive a confirmation of transfer of VAT funds from the payment processor server system, receive a refund confirmation from the payment processor server system, and in response to receiving the refund confirmation, send a VAT refund message to the payment processor server system. The processor is further configured to, if the determination is not successful, transmit a failure message that indicates that the payment transaction cannot be processed to cause the payment processor server system to refrain from processing the payment transaction.

With the computerized VAT system according to the fifteenth aspect, it is possible for a point-of-sale system to receive messages pertaining to the determined VAT percentage and VAT funds instead of locally processing, thus reducing memory requirements at the point-of-sale system. Further, if the determination is not successful, it is possible to reduce processing invalid payment transitions and reduce processing demands at the point-of-sale system.

In accordance with a sixteenth aspect of the present invention, the computerized VAT system according to the fifteenth aspect is provided, wherein the plurality of VAT calculation parameters including a plurality of consumer parameters selected from the group consisting of, a consumer billing address, a consumer payment address, an IP address associated with the consumer, a VAT number associated with the consumer, a self-declared location of the consumer, a telephone number of the consumer, and a payment method of the consumer.

With the computerized VAT system according to the sixteenth aspect, it is possible to determine a location of the consumer for use in determining the VAT percentage.

In accordance with a seventeenth aspect of the present invention, the computerized VAT system according to the sixteenth aspect is provided, wherein the location of the consumer is determined by the consumer billing address or the consumer payment address.

With the computerized VAT system according to the seventeenth aspect, it is possible to determine a country, a region, and/or a city of the location of the consumer.

In accordance with an eighteenth aspect of the present invention, the computerized VAT system according to the sixteenth aspect is provided, wherein the location of the consumer is determined by one or more of one or more of the consumer billing address, the consumer payment address, the IP address associated with the consumer, and the VAT number associated with the consumer.

With the computerized VAT system according to the eighteenth aspect, it is possible to reduce an error in the determination of the location of the consumer.

In accordance with a nineteenth aspect of the present invention, the computerized VAT system according to the fifteenth aspect is provided, wherein the plurality of VAT calculation parameters include a plurality of goods and services parameters selected from the group consisting of an identity of the good or service, a quantity of the good or service, and a point of origin of the good or service.

With the computerized VAT system according to the nineteenth aspect, it is possible to determine the corresponding VAT regulations pertaining to the good or service at the processor, and thus help to reduce processing demands at a point-of-sale system.

In accordance with a twentieth aspect of the present invention, the computerized VAT system according to the nineteenth aspect is provided, wherein the determination of the VAT percentage is based on the identity of the good or service.

With the computerized VAT system according to the twentieth aspect, it is possible to determine the corresponding VAT regulations pertaining to the identity of the good or service at the processor, and thus help to reduce processing demands at a point-of-sale system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is a schematic view of a computerized value-added tax (VAT) system performing a VAT calculation.

FIG. 1B shows additional details of VAT calculation parameters of the computerized VAT system of FIG. 1A.

FIG. 1C shows additional details of an merchant configuration interface of the computerized VAT system of FIG. 1A.

FIG. 1D shows additional details of an error message and a successful calculation message of the computerized VAT system of FIG. 1A.

FIG. 2 is a schematic view of the computerized VAT system of FIG. 1A performing a sales process.

FIG. 3 is a schematic view of the computerized VAT system of FIG. 1A performing a refund process.

FIGS. 4A-E show a consumer device displaying an example merchant ecommerce portal of the computerized VAT system of FIG. 1A.

FIG. 5 shows a communications flow diagram for a computerized VAT method according to one example embodiment of the present disclosure.

FIG. 6 shows a flowchart for a computerized VAT method according to one example embodiment of the present disclosure.

FIG. 7 is an example computing system according to an embodiment of the present disclosure.

### DETAILED DESCRIPTION

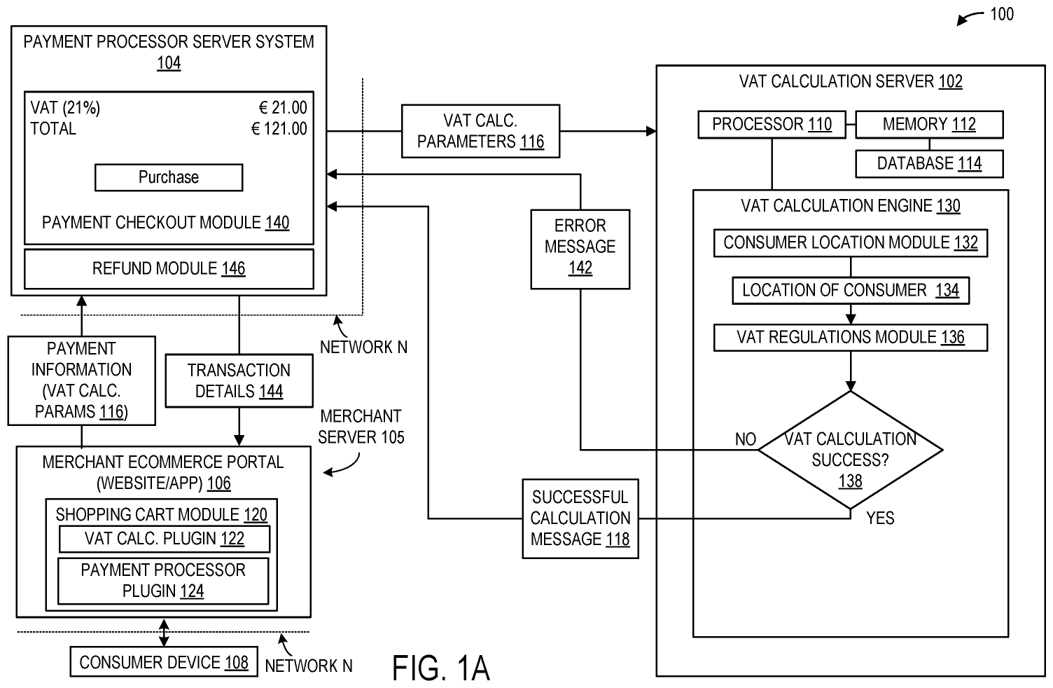

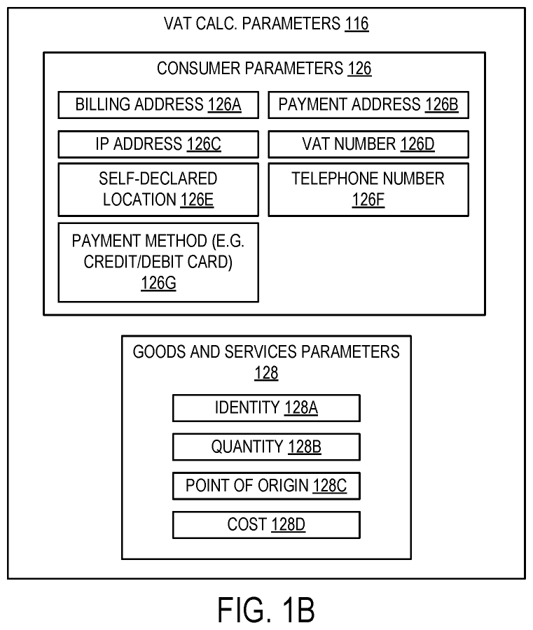

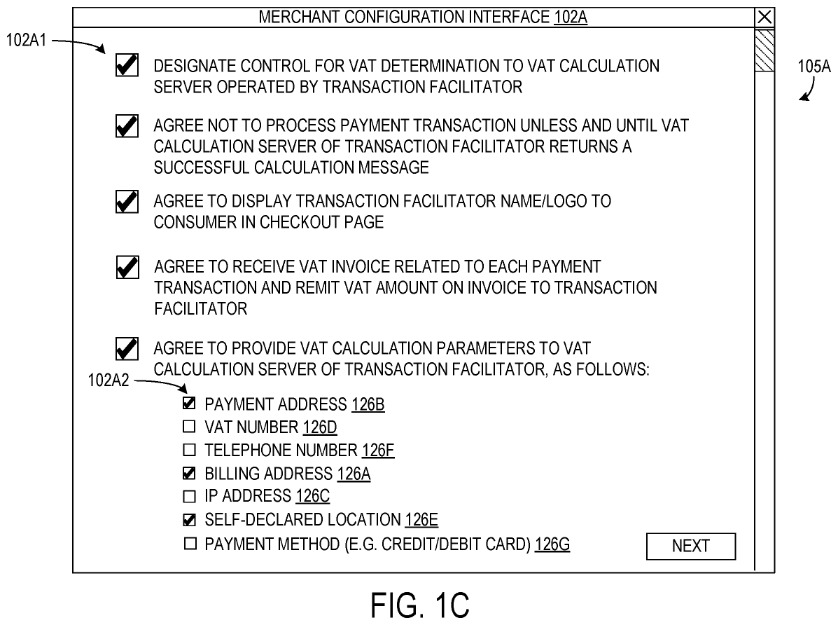

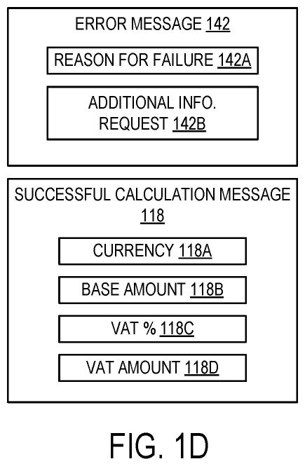

To address the issues discussed above, as shown in FIG. 1A a computerized value-added tax (VAT) system 100 is provided. The computerized VAT system 100 is illustrated in FIG. 1A performing a VAT calculation process. The computerized VAT system 100 comprises a VAT calculation server 102 in communication with a payment processor server system 104 via a computer network N such as the Internet. The payment processor server system 104 is operated by a payment provider, and the VAT calculation server 102 may be operated by the payment provider itself, or by a third-party transaction facilitator. While depicted as separate server systems, the payment processor server system 104 and VAT calculation server 102 may be configured as distinct microservices operating on a single server system in an alternative embodiment in which the payment provider and transaction facilitator are the same entity. The payment processor server system 104 is also in communication with a merchant ecommerce portal 106, which may be a website or application served by a merchant server 105, via the computer network N. The merchant ecommerce portal 106 is accessible by, for example, a consumer device 108 associated with a consumer, also via the computer network N.

The VAT calculation server 102 includes a processor 110 and associated memory 112 in which a database 114 is stored. The database 114 stores a database of tax rules including tax classifications for different products and tax rates that apply in different geographic regions. The database also stores merchant configuration settings, in which each merchant specifies the goods they sell and geographic regions in which they sell, as well as the particular VAT calculation parameters that will be exchanged during the VAT determination process described below.

In the VAT calculation process, the processor 110 is configured to execute instructions using the memory 112 to receive from the payment processor server system 104, at least one of a plurality of VAT calculation parameters 116 associated with a payment transaction. The processor 110 is further configured to determine a location of a consumer initiating the request for the transaction from the consumer device, based upon the at least one of the plurality of VAT calculation parameters 116. The processor is further configured to perform a determination of a VAT percentage for the transaction based upon the at least one of the plurality of VAT calculation parameters 116 and the location of the consumer. The determination of the VAT percentage may also include a determination of whether the merchant or the consumer is originally liable to pay the VAT, so the transaction facilitator can later pay the VAT on behalf of the liable party, and invoice the VAT amount appropriately, as described below. If the determination of the VAT percentage is successful (that is, is completed successfully by the VAT calculation server 102), the processor 110 is further configured to transmit a successful calculation message 118 to the payment processor server system 104. The successful calculation message 118 includes data used by the payment processor server system 104 to transfer funds. Example data types included in this data are provided in FIG. 1D and include a currency 118A used for the payment transaction, a base amount 118B for the payment transaction, the determined VAT percentage 118C, and a VAT amount 118D. Returning to FIG. 1A, the processor 110 is further configured to transmit the determined VAT percentage 118C to the payment processor server system 104 along with the successful calculation message 118. The communication of the successful calculation message and the determined VAT percentage 118C may occur either in one consolidated message or in a plurality of separate messages. If the determination fails (that is, is not completed successfully by the VAT calculation server 102), then the processor 110 is configured to transmit a failure message that indicates that the payment transaction cannot be processed to the payment processor server system 104, to cause the payment processor server system 104 to refrain from processing the payment transaction. A more detailed description of the computerized VAT system 100 performing the VAT calculation process is now provided using the following example transaction. It will be appreciated that while the following description uses a VAT calculation process, the computerized VAT system 100 may calculate any indirect taxes in addition to VAT, such as goods and services tax (GST), or sales tax.

Continuing with FIG. 1A, the consumer accesses the merchant ecommerce portal 106 via the consumer device 108. The consumer device 108 may be a desktop computer, a laptop, a smart phone, a tablet, or any other electronic device capable of accessing the Internet. In the illustrated example, the consumer has selected items for purchase (totaling €100 in this example) using a shopping cart module 120. The shopping cart module 120 includes a VAT calculation plugin 122 and a payment processor plugin 124. The payment processor plugin 124 collects data inputs from the shopping cart module such as identities and costs of items selected for purchase and payment credentials (e.g., credit card number, bank account number, or other credentials associated with the payment processor). This data from the shopping cart module may be referred to as transaction data. The VAT calculation plugin 122 collects a plurality of VAT calculation parameters 116 (shown in detail in FIG. 1B) including a plurality of consumer parameters 126 and a plurality of goods and services parameters 128 from the shopping cart module 120 and/or merchant ecommerce portal 106.

The plurality of consumer parameters 126 are received from the consumer at checkout via the shopping cart module or retrieved from a stored consumer profile associated with the consumer by the merchant ecommerce portal 106 at the request of the VAT calculation plugin 122 via the shopping cart module 120, which has access to such stored profile data. The plurality of consumer parameters 126 are selected from the group consisting of: a consumer billing address 126A, a consumer payment address 126B, an Internet protocol (IP) address 126C associated with the consumer, the IP address 126C being determined during the example transaction. The plurality of consumer parameters may further include a VAT number 126D associated with the consumer, a self-declared location 126E of the consumer, a telephone number 126F of the consumer, or a payment method 126G (e.g., credit card or debit card) of the consumer. Goods and services parameters 128 include an identity 128A of the good or service, quantity 128B of the good or service, point of origin 128C of the good or service, and cost 128D of the good or service. It will be appreciated that the above consumer parameters 126 and goods and services parameters 128 are exemplary, and that other consumer parameters 126 or goods and services parameters 128 may be used.

Referring briefly to FIG. 1C, a subset of the consumer parameters 126 in the VAT calculation parameters 116 parameters may be selected beforehand by the merchant using a merchant configuration interface 102A, for use with transactions for a particular merchant ecommerce portal 106. The merchant configuration interface 102A is served from the VAT calculation server 102 to a merchant administrative device 105A. The merchant configuration interface includes selectors 102A1 configured to receive merchant input confirming that (1) control is designated for VAT determination from the merchant to the VAT calculation server operated by the transaction facilitator, (2) payments will not be processed until the VAT calculation server returns a successful calculation message, (3) the transaction facilitator identity (e.g., name and/or logo) will be displayed to the consumer in the checkout page at the point of transaction, and (4) that a VAT invoice for the determined amount will be paid upon receipt from the transaction facilitator. The merchant configuration interface 102A further includes a plurality of selectors 102A2 to choose a predetermined number of consumer parameters 126 upon which the VAT determination will be based, from among the consumer billing address 126A, consumer payment address 126B, IP address 126C associated with the consumer, VAT number 126D associated with the consumer, self-declared location 126E of the consumer, telephone number 126F of the consumer, and payment method 126G (e.g., credit card or debit card) of the consumer. In one particular embodiment, three parameters are selected by the merchant. In other embodiments, another predetermined number may be selected, or an unlimited number may be selected. It will be appreciated that the configuration may be different for each merchant using the VAT calculation server 102. Once the configuration settings are selected, they may be transmitted to the VAT calculation server 102 and stored. The merchant shopping cart module may be configured to send the data selected for each transaction and the VAT calculation server 102 may be configured to perform VAT determinations based upon the selected parameters. Although not shown, another merchant configuration interface 102A may be provided to enter merchant-specific data for the goods and services parameters 128.

Returning now to FIG. 1A, payment information including VAT calculation parameters 116 is transmitted to the VAT calculation server 102 via the payment processor server system 104. While FIG. 1A shows one payment processor server system 104 processing both payment funds and VAT funds, it will be appreciated that payment processor server system 104 may include more than one payment processor server system 104. In such a case, one payment processor server system 104 processes payment funds while another payment processor server system 104 processes VAT funds. The VAT calculation server 102 includes a VAT calculation engine 130 which uses a consumer location module 132 to determine the location of the consumer 134 based upon at least one of the consumer parameters 126. The consumer location module 132 determines the location of the consumer 134 by using a country, a region, and/or a city of the consumer billing address 126A or the consumer payment address 126B. Additionally or alternatively, the consumer location module 132 determines the location of the consumer 134 by the IP address 126C associated with the consumer, e.g., an IP address of the consumer device 108. Additionally or alternatively the consumer location module 132 determines the location of the consumer 134 by the VAT number 126D associated with the consumer. Additionally or alternatively, the consumer location module 132 determines the location of the consumer 134 by a self-declared location 126E of the consumer. This is accomplished by a prompt in the merchant ecommerce portal 106 requesting that the consumer enter a country or region in which the consumer is located. Additionally or alternatively, the consumer location module 132 determines the location of the consumer 134 by a country code and/or area code of the telephone number 126F of the consumer. Additionally or alternatively, the consumer location module 132 determines the location of the consumer 134 by the payment method 126G of the consumer. For example, certain digits of some credit card and/or debit card numbers are associated with an issuing bank, the issuing bank being in a known location. In a case that the payment method 126G of the consumer is a credit card, the credit card number is used to identify the issuing bank, and the known location of the bank is used as the location of the consumer 134. It will be appreciated that the above method for using the credit card number is merely one example of using the payment method 126G of the consumer to determine the location of the consumer 134, and that any other suitable method may be used. In one configuration, the location of the consumer 134 is determined by three of the plurality of consumer parameters 126, however in other configurations, the location of the consumer 134 is determined by one, two, four, five, or any other suitable number of consumer parameters 126.

A VAT regulations module 136 uses as input the location of the consumer 134 and the at least one of the plurality of VAT calculation parameters 116. The VAT regulations module 136 accesses the database 114 storing VAT rates for goods and services for 1) categories of goods and services and 2) regions. Regions refer to countries, states, provinces, cities, geographical areas, or any other entities having tax authorities and/or VAT regulations. By comparing the identity 128A of the good or service with the categories of goods and services in the database, the VAT regulations module determines the VAT percentage 118C. Upon a successful VAT calculation (YES at 138), the successful calculation message 118 is transmitted to the payment processor server system 104. A payment checkout module 140 receives the successful calculation message 118 and transmits transaction details 144 to the merchant ecommerce portal 106 via the payment processor plugin 124.

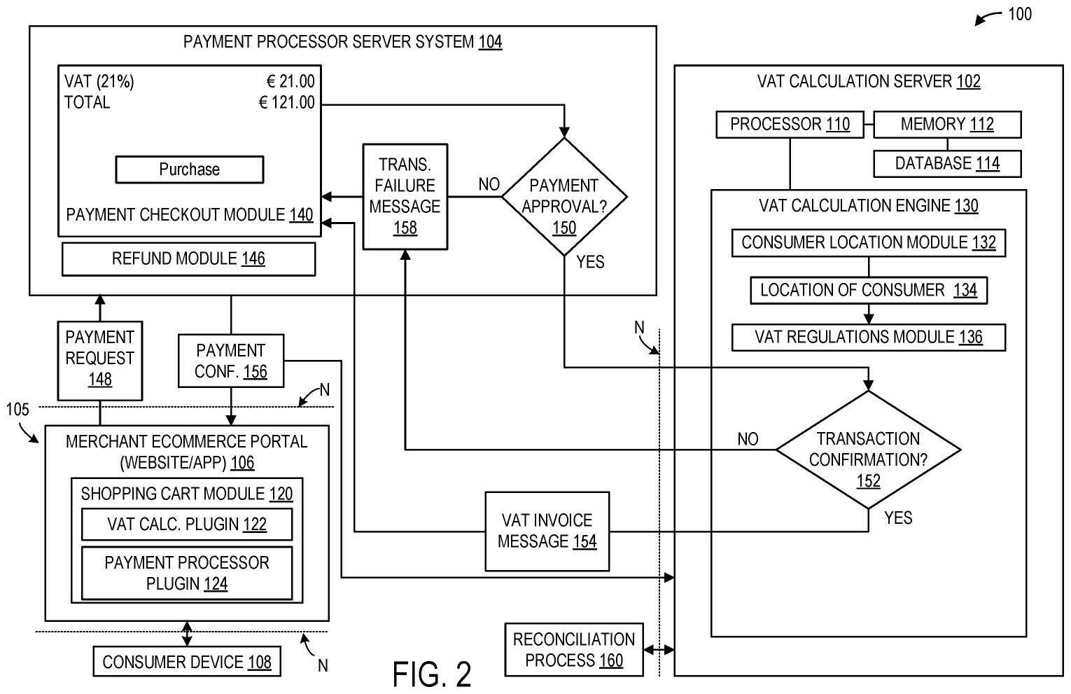

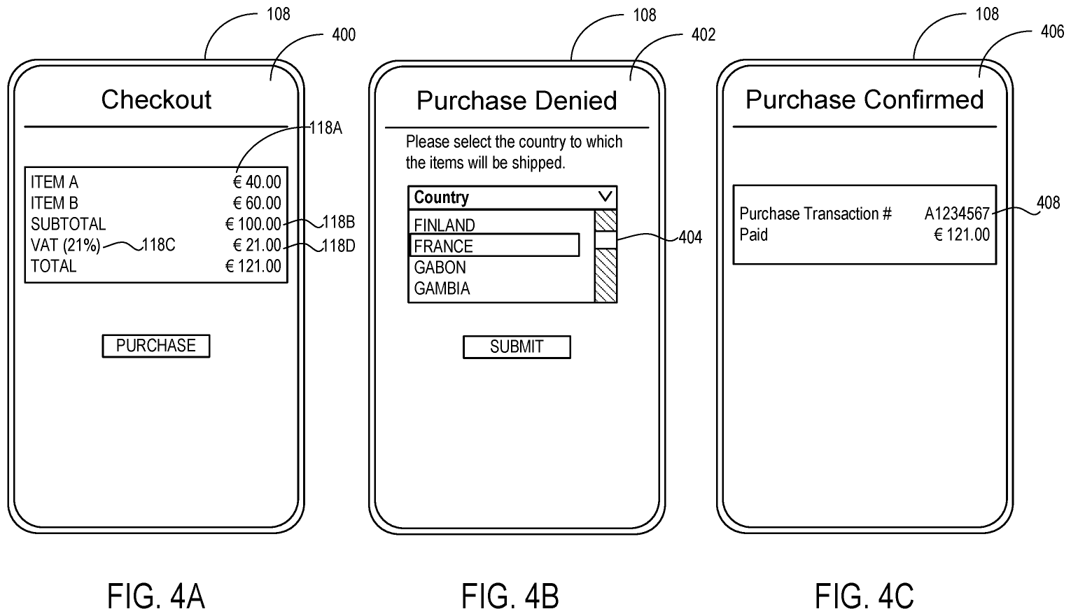

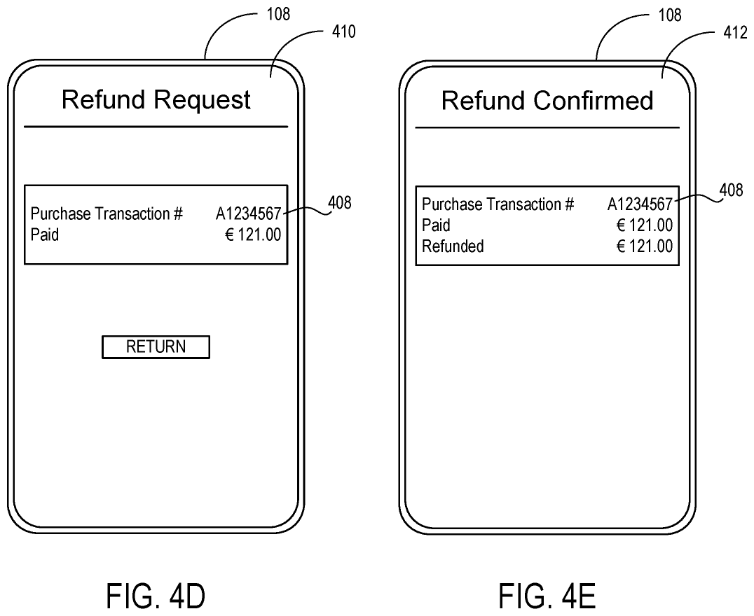

FIG. 4A shows the consumer device 108 displaying a checkout page 400 generated by the payment processor plugin 124. The checkout page 400 shows the currency 118A (Euro in this example) a list of items selected for purchase (items A and B at €40.00 and €60.00 respectively), a subtotal equivalent to the base amount 118B (€100.00), a VAT percentage 118C (21%), and VAT amount 118D (€21.00) and total cost (€121.00). By tapping “PURCHASE” the consumer initiates a payment process which will be described in detail below in relation to FIG. 2.

Returning now to FIG. 1A, in a case that the VAT calculation is not successful (NO at 138) the VAT calculation engine 130 transmits an error message 142 to the payment processor server system 104. As shown in FIG. 1D, the error message includes a reason for failure 142A. Examples for the reason for failure 142A include incorrectly entered VAT calculation parameters 116 (e.g., incorrectly entered consumer billing address 126A or consumer payment address 126B) or conflicting consumer parameters 126 (e.g., a consumer billing address 126A for a country that is different from the country code found in the telephone number 126F). In such a case, the error message 142 includes an additional information request 142B. The payment checkout module 140 receives the error message 142 and prompts the merchant ecommerce portal 106, via the payment processor plugin 124, to display a purchase denied message 402 and a country selection prompt 404 (FIG. 4B) whereby the consumer enters the self-declared location 126E by selecting a country and tapping “SUBMIT”. The self-declared location 126E is transmitted to the VAT calculation server 102 and VAT calculation engine 130 performs a successful VAT calculation (YES at 138). A refund module 146 enables the consumer to receive a refund and will be discussed in further detail below.

FIG. 2 shows the computerized VAT system 100 performing a sales process. After the consumer taps “SUBMIT” (FIG. 4B) a payment request 148 is sent to the payment processor server system 104. In a case that the payment is approved by the payment processor server system 104 (YES at 150) and the transaction is confirmed by the VAT calculation server 102 (YES at 152), a VAT invoice is sent from the VAT calculation server 102 to the payment processor server system 104. The VAT invoice message 154 includes a request for transfer of VAT funds, and thus the VAT calculation server 102 sends a request for transfer of VAT funds for the payment transaction to the payment processor server system 104. The message may also include details that enable the seller to send the goods/services in a manner compliant with country customs and/or tax requirements. A payment confirmation 156 is sent from the payment processor server system 104 to the merchant ecommerce portal 106. FIG. 4C shows the consumer device 108 displaying a purchase confirmation message 406 including a purchase transaction number 408 and the total cost (€121.00).

Returning to FIG. 2, the payment confirmation 156 is sent from the payment processor server system 104 to the VAT calculation server 102. The VAT invoice 154 includes a confirmation of transfer of VAT funds, and the processor 110 is further configured to receive the confirmation of transfer of VAT funds from the payment processor server system 104. In a case that the payment is not approved by the payment processor server system 104 (NO at 150) or the transaction is not confirmed by the VAT calculation server 102 (no at 152), a transaction failure message 158 is delivered to the payment checkout module 140. The transaction failure message 158 includes a reason for failure. The processor 110 is further configured to execute a reconciliation process 160 whereby funds are transferred to a relevant tax authority or other recipient of VAT funds, when the transaction is successfully processed.

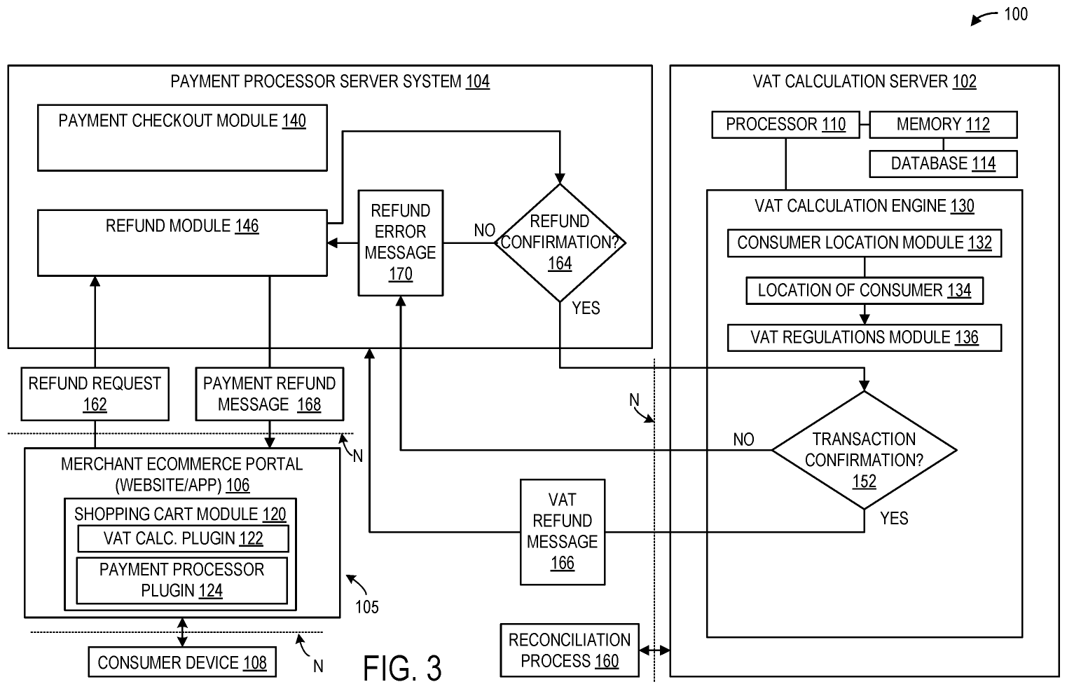

FIG. 4D shows the consumer device 108 displaying a refund request page 410 generated by the payment processor plugin 124. The checkout page 400 shows the purchase transaction number 408 and the total amount paid (€121.00). By tapping “RETURN” the consumer initiates a refund process which will now be described in relation to FIG. 3.

Continuing to FIG. 3, the shopping cart module 120 sends a refund request 162 to the payment processor server system 104. The refund module 146 performs a refund confirmation (YES at 164). The processor 110 is further configured to receive the refund confirmation from the payment processor server system 104 and in response to receiving the refund confirmation, send a VAT refund message 166 to the payment processor server system. The refund module 146 sends a payment refund message 168 to the merchant ecommerce portal 106. FIG. 4E shows the consumer device 108 displaying a payment refund page 412 generated by the payment processor plugin 124. The payment refund page 412 shows the purchase transaction number 408, the total amount paid (€121.00), and an amount refunded (€121.00).

Returning to FIG. 3, in a case that the refund is not approved by the payment processor server system 104 (NO at 164) or the transaction is not confirmed by the VAT calculation server 102 (NO at 152), a refund error message 170 is delivered to the refund module 146. The refund error message 170 includes a reason for failure. The processor 110 is further configured to execute a reconciliation process 160 whereby VAT funds received by the transaction facilitator operating the VAT calculation server 102 for the transaction are confirmed to match a ledger amount of VAT owed for the transaction, and then are paid to the relevant tax authority.

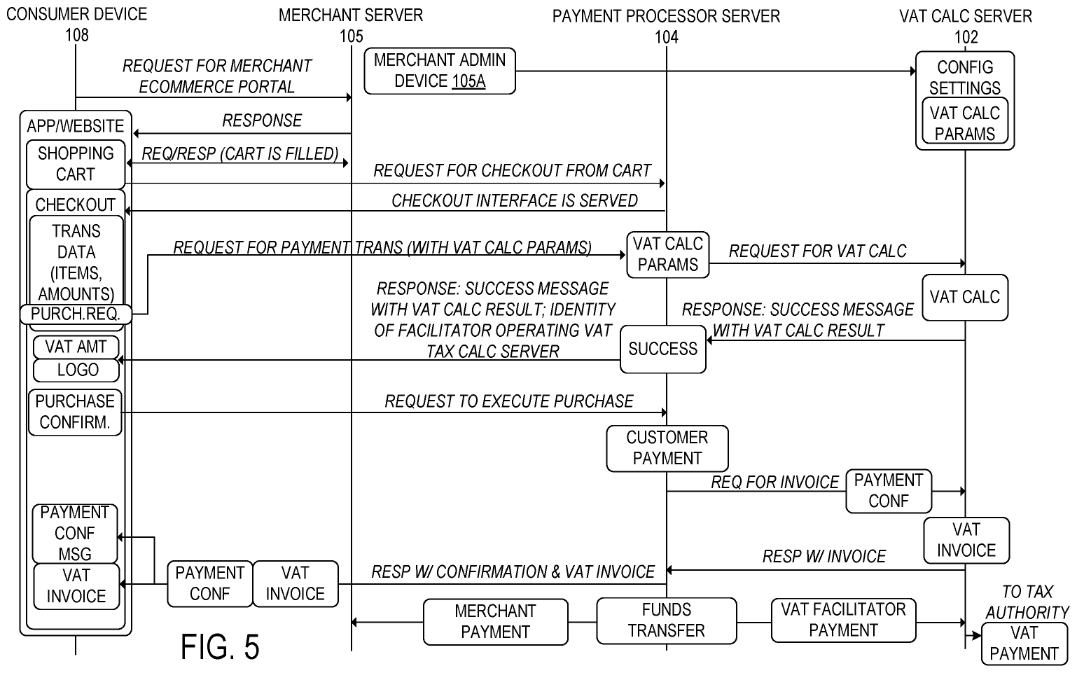

Turning to FIG. 5, a communications flow diagram is provided illustrating an example abbreviated communications flow among the consumer device 108, merchant server 105, payment processor server system 104, and VAT calculation server 102. Not all process steps of the Figures above are illustrated in FIG. 5, rather the overall communications flow is shown in an abbreviated form. Initially, a merchant administrative device 105A is configured to send merchant configuration settings including VAT calculation parameters 116 such as those selected via the merchant configuration interface 102A described above, to the VAT calculation server 102. At a later shopping stage after the configuration, a consumer operating consumer device 108 sends a request (such as a hypertext transfer protocol (HTTP) request) for the merchant ecommerce portal 106. The appropriate application or website interface is downloaded in response from the merchant server and displayed on the consumer device 108. Within the application/website a shopping cart is displayed, the shopping cart being generated by shopping cart module 120 describe above. The consumer shops via the merchant ecommerce portal 106 sending requests and responses back and forth between the consumer device 108 and the merchant server 105, and as a result of this shopping activity, selects one or more items for purchase in the shopping cart.

When the consumer is ready to check out, the consumer may select a request checkout selector (not shown) that causes a request for checkout to be sent from shopping cart module 120 of the consumer device 108 to the payment processor server system 104. A checkout interface (alternatively referred to as the checkout page above) is sent from the payment processor server system 104 to the consumer device 108. The shopping cart module 120 has passed the appropriate transaction details 144 to the checkout interface, and thus the checkout interface displays the items and amounts of the requested purchase transaction. By selecting a purchase selector (not shown), a purchase request for a payment transaction is sent to the payment processing server from the checkout interface, along with the VAT calculation parameters 116 discussed above. In turn, the VAT calculation parameters 116 are sent from the payment processor server system 104 to the VAT calculation server 102, in a request for VAT calculation. The VAT calculation server 102, performs the VAT calculation based on the VAT calculation parameters 116 as described elsewhere herein, and returns to the payment processor server system 104 a response in the form of a success message containing the VAT calculation amount (or rate).

The payment processor server system 104, in turn, returns a response in the form of a success message containing the VAT amount, and the identity of the transaction facilitatory operating the VAT calculation server, to the consumer device 108. The consumer device 108 displays a logo, name or other indicia indicating the transaction facilitator, along with the VAT amount, on the checkout interface to the consumer. In some configurations, the items and amounts involved in the purchased transaction are also displayed. The consumer can select a purchase confirmation selector (not shown) to confirm purchase, which causes a request to execute purchase to be sent form the consumer device 108 to the payment processor server system 104.

Following receipt of this request, the payment processor server system 104 is configured to process the customer payment, and send a request for VAT invoice, along with a payment confirmation, to the VAT calculation server 102. The VAT calculation server 102 is configured to generate the VAT invoice, and respond with the VAT invoice to the payment processor server system 104. The payment processor server system 104 is, in turn, configured to send a response with a confirmation of the payment transaction and the VAT invoice (or alternatively the VAT invoice number) to the consumer device 108. The payment processor server system 104 is configured to execute funds transfer, to distribute funds owed to the merchant in the form of a merchant payment, and funds owed to the transaction facilitator in the form of a VAT facilitator payment. The VAT calculation server 102, is configured to perform reconciliation, and confirm the VAT facilitator payment matches the VAT amount in a ledger maintained at the VAT calculation server 102, and upon such confirmation, is configured to send payment of the VAT amount to the relevant tax authority.

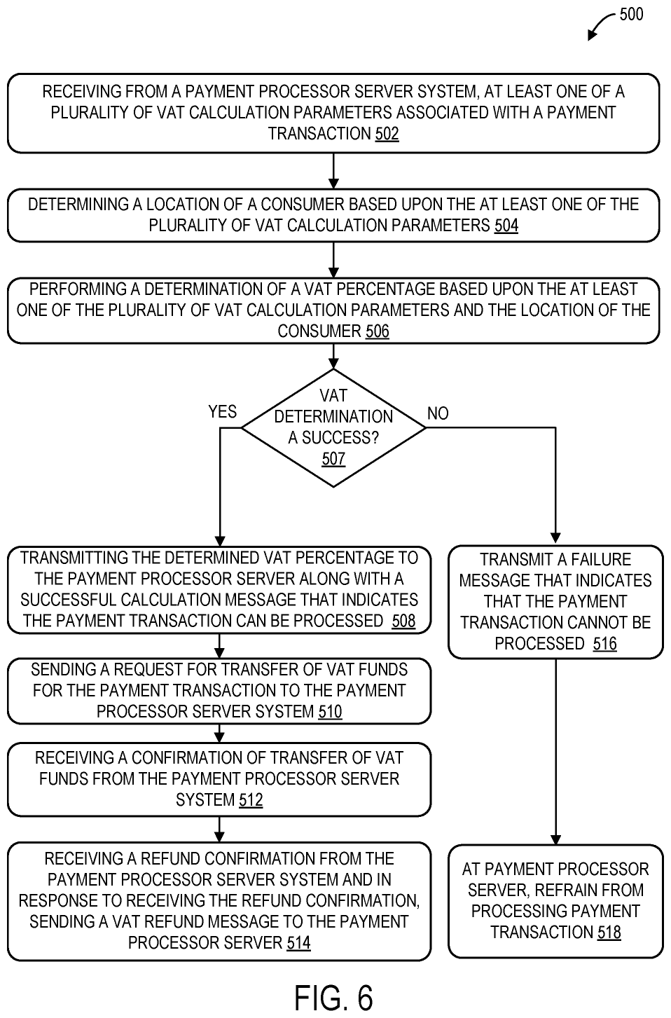

Turning to FIG. 6 an example computerized VAT method 500 will now be described. It will be appreciated that the method 500 may be implemented using the above described computerized VAT system 100 or other suitable hardware and software componentry. The method 500 may be used with a server including a processor and associated memory, the processor configured to execute instructions using the memory. At 502, the method 500 comprises receiving from a payment processor server system, at least one of a plurality of VAT calculation parameters associated with a payment transaction. The plurality of VAT calculation parameters may include a plurality of consumer parameters selected from the group consisting of: a consumer billing address, a consumer payment address, an IP address associated with the consumer, a VAT number associated with the consumer, a self-declared location of the consumer, a telephone number of the consumer, and a payment method of the consumer. The location of the consumer may be determined by three of the plurality of consumer parameters. The plurality of VAT calculation parameters may include a plurality of goods and services parameters selected from the group consisting of: an identity of the good or service, a quantity of the good or service, and a point of origin of the good or service. At 504, the method 500 comprises determining a location of a consumer based upon the at least one of the plurality of VAT calculation parameters. This step also determines whether the merchant or consumer is liable for the VAT due for the transaction, and stores the result in order to properly generate and send a VAT invoice. At 506, the method 500 further comprises performing a determination of a VAT percentage based upon the at least one of the plurality of VAT calculation parameters and the location of the consumer. At 507, the method 500 includes determining if the VAT determination was a success or failure. If the VAT determination is a success, then steps 508-514 are performed, and if the VAT determination is a failure, then steps 516 and 518 are performed. At 508, the method 500 further comprises, if the VAT determination is a success, transmitting the determined VAT percentage to the payment processor server. It will be appreciated that in a confirmation step, the merchant and/or payment processor operating the payment transaction server may have agreed beforehand to respect the VAT determination received from the VAT calculation server, and not to adjust or modify the VAT determination in any way. At 510, the method 500 further comprises sending a request for transfer of VAT funds for the payment transaction to the payment processor server system. At 512, the method 500 further comprises receiving a confirmation of transfer of VAT funds from the payment processor server system. At 514, the method 500 further comprises receiving a refund confirmation from the payment processor server system and in response to receiving the refund confirmation, sending a VAT refund message to the payment processor server. At 516, the method 500 further comprises, if the VAT determination is a failure, then transmitting a failure message that indicates that the payment of the transaction cannot be processed. The merchant and/or payment processor may have agreed prior to implementation of the method to follow and respect the failure message, thereby giving the transaction facilitator the control and authority to deny the payment transaction upon a failure in VAT determination. Accordingly, at 518, the method 500 may further include, at the payment processor server, refraining from processing the payment transaction in response to receiving the failure message.

In some embodiments, the methods and processes described herein may be tied to a computing system of one or more computing devices. In particular, such methods and processes may be implemented as a computer-application program or service, an application-programming interface (API), a library, and/or other computer-program product.

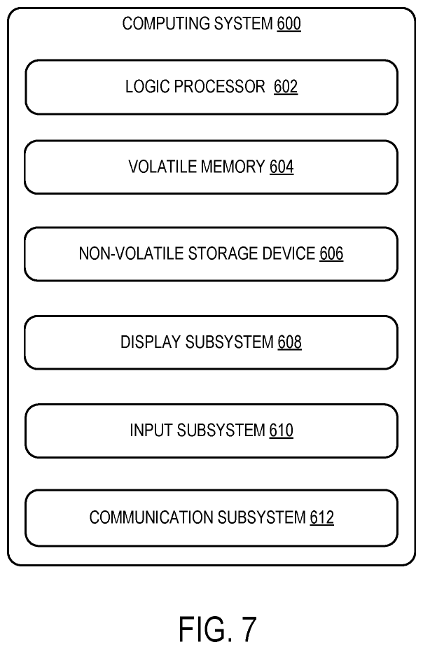

FIG. 7 schematically shows a non-limiting embodiment of a computing system 600 that can enact one or more of the methods and processes described above. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 600 includes a logic processor 602 volatile memory 604, and a non-volatile storage device 606. Computing system 600 may optionally include a display subsystem 608, input subsystem 610, communication subsystem 612, and/or other components not shown in FIG. 7.

Logic processor 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the logic processors to implement the methods and processes described herein. When such methods and processes are implemented, the state of non-volatile storage device 606 may be transformed—e.g., to hold different data.

Non-volatile storage device 606 may include physical devices that are removable and/or built-in. Non-volatile storage device 606 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by logic processor 602 to temporarily store information during processing of software instructions. It will be appreciated that volatile memory 604 typically does not continue to store instructions when power is cut to the volatile memory 604.

Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 600 to send and/or receive messages to and/or from other devices via a network such as the Internet.

1. A computerized value-added tax (VAT) system comprising:
a VAT calculation server including a processor and associated memory, the processor configured to execute instructions using the memory to:
receive from a payment processor server system, at least one of a plurality of VAT calculation parameters associated with a payment transaction;
determine a location of a consumer based upon the at least one of the plurality of VAT calculation parameters;
perform a determination of a VAT percentage based upon the at least one of the plurality of VAT calculation parameters and the location of the consumer; and
if the determination is successful, then
transmit the determined VAT percentage to the payment processor server system along with a successful calculation message that indicates the payment transaction can be processed;
send a request for transfer of VAT funds for the payment transaction to the payment processor server system; and
receive a confirmation of transfer of VAT funds from the payment processor server system; else
transmit a failure message that indicates that the payment transaction cannot be processed to cause the payment processor server system to refrain from processing the payment transaction.

2. The computerized VAT system of claim 1, wherein the plurality of VAT calculation parameters include a plurality of consumer parameters selected from the group consisting of:
a consumer billing address;
a consumer payment address;
an IP address associated with the consumer;
a VAT number associated with the consumer;
a self-declared location of the consumer;
a telephone number of the consumer; and
a payment method of the consumer.

3. The computerized VAT system of claim 2, wherein the location of the consumer is determined by the consumer billing address.

4. The computerized VAT system of claim 2, wherein the location of the consumer is determined by the consumer payment address.

5. The computerized VAT system of claim 2, wherein the location of the consumer is determined by one or more of the consumer billing address, the consumer payment address, the IP address associated with the consumer, and the VAT number associated with the consumer.

6. The computerized VAT system of claim 1, wherein the plurality of VAT calculation parameters include a plurality of goods and services parameters selected from the group consisting of:
an identity of the good or service;
a quantity of the good or service; and
a point of origin of the good or service.

7. The computerized VAT system of claim 6, wherein the determination of the VAT percentage is based on the identity of the good or service.

8. The computerized VAT system of claim 1, wherein the processor is further configured to:
receive a refund confirmation from the payment processor server system and in response to receiving the refund confirmation, send a VAT refund message to the payment processor server system.

9. A computerized value-added tax (VAT) method for use with a server including a processor and associated memory, the processor configured to execute instructions using the memory, the method comprising:
at the processor:
receiving from a payment processor server system, at least one of a plurality of VAT calculation parameters associated with a payment transaction;
determining a location of a consumer based upon the at least one of the plurality of VAT calculation parameters;
performing a determination of a VAT percentage based upon the at least one of the plurality of VAT calculation parameters and the location of the consumer;
if the determination is successful, then
transmitting the determined VAT percentage to the payment processor server system along with a successful calculation message that indicates the payment transaction can be processed;
sending a request for transfer of VAT funds for the payment transaction to the payment processor server system; and
receiving a confirmation of transfer of VAT funds from the payment processor server system; else
transmitting a failure message that indicates that the payment transaction cannot be processed to cause the payment processor server system to refrain from processing the payment transaction.

10. The method of claim 9, wherein the plurality of VAT calculation parameters include a plurality of consumer parameters selected from the group consisting of:
a consumer billing address;
a consumer payment address;
an IP address associated with the consumer;
a VAT number associated with the consumer;
a self-declared location of the consumer;
a telephone number of the consumer; and
a payment method of the consumer.

11. The method of claim 10, wherein the location of the consumer is determined by one or more of the consumer billing address, the consumer payment address, IP address associated with the consumer, and the VAT number associated with the consumer.

12. The method of claim 9, wherein the plurality of VAT calculation parameters include a plurality of goods and services parameters selected from the group consisting of:
an identity of the good or service;
a quantity of the good or service; and
a point of origin of the good or service.

13. The method of claim 12, wherein the determination of the VAT percentage is based on the identity of the good or service.

14. The method of claim 9, further comprising:
receiving a refund confirmation from the payment processor server system and in response to receiving the refund confirmation, sending a VAT refund message to the payment processor server system.

15. A computerized value-added tax (VAT) system comprising:
a VAT calculation server including a processor and associated memory, the processor configured to execute instructions using the memory to:
receive from a payment processor server system, at least one of a plurality of VAT calculation parameters associated with a payment transaction;
determine a location of a consumer based upon the at least one of the plurality of VAT calculation parameters;
perform a determination of a VAT percentage based upon the at least one of the plurality of VAT calculation parameters and the location of the consumer;
if the determination is successful, then
transmit the determined VAT percentage to the payment processor server system along with a successful calculation message that indicates the payment transaction can be processed;
send a request for transfer of VAT funds for the payment transaction to the payment processor server system;
receive a confirmation of transfer of VAT funds from the payment processor server system;
receive a refund confirmation from the payment processor server system; and
in response to receiving the refund confirmation, send a VAT refund message to the payment processor server system; else
transmit a failure message that indicates that the payment transaction cannot be processed to cause the payment processor server system to refrain from processing the payment transaction.

16. The computerized VAT system of claim 15, wherein the plurality of VAT calculation parameters including a plurality of consumer parameters selected from the group consisting of:
a consumer billing address;
a consumer payment address;
an IP address associated with the consumer;
a VAT number associated with the consumer;
a self-declared location of the consumer;
a telephone number of the consumer; and
a payment method of the consumer.

17. The computerized VAT system of claim 16, wherein the location of the consumer is determined by the consumer billing address or the consumer payment address.

18. The computerized VAT system of claim 16, wherein the location of the consumer is determined by one or more of one or more of the consumer billing address, the consumer payment address, the IP address associated with the consumer, and the VAT number associated with the consumer.

19. The computerized VAT system of claim 15, wherein the plurality of VAT calculation parameters include a plurality of goods and services parameters selected from the group consisting of:
an identity of the good or service;
a quantity of the good or service; and
a point of origin of the good or service.

20. The computerized VAT system of claim 19, wherein the determination of the VAT percentage is based on the identity of the good or service.
